(19) United States
(12) Patent Application Publication
(10) Pub. No.: US 2023/0422168 A1
(43) Pub. Date: Dec. 28, 2023

(54) Strategies for Power Efficient Configuration of a Wireless Access Network

(71) Applicant: Telefonaktiebolaget LM Ericsson (PUBL), Stockholm (SE)

(72) Inventors: Ali Nader, MALMÖ (SE); Sina Maleki, MALMÖ (SE); IImiawan Shubhi, MALMÖ (SE); Andres Reial, HÖLLVIKEN (SE)

(21) Appl. No.: 18/034,814

(22) PCT Filed: Nov. 3, 2021
(86) PCT No.: PCT/EP2021/080480

§ 371 Date: May 1, 2023

Related U.S. Application Data
(60) Provisional application No. 63/109,117, filed on Nov. 3, 2020.
(60) Provisional application No. 63/110,729, filed on Nov. 6, 2020.

(51) Int. Cl. H04W 52/02

(52) U.S. Cl. CPC H04W 52/0212

(57) ABSTRACT

A computer implemented method, performed in a network node (170, 700, 800, 900), for configuring one or more secondary component carriers, Scells, and/or at least one bandwidth part, BWP, in a wireless access network (100) fora wireless device (150), the method comprising obtaining (S1) control channel capacity data indicative of a nominal capacity of a current control channel of the wireless access network (100), determining (S2) a control channel load of the wireless access network (100), evaluating (S3) one or more alternative Scell and/or BWP configurations of the wireless access network (100) for the wireless device (150) in terms of an energy consumption of the wireless device (150), where each of the one or more alternative Scell and/or BWP configurations of the wireless access network (100) is associated with an increased control channel capacity compared to the nominal capacity of the current control channel, detecting (S4) control channel resource deficit based on the control channel load and on the control channel capacity data, and, in response to detecting control channel resource deficit, selecting (S5) an Scell and/or BWP configuration from the one or more alternative Scell and/or BWP configurations based on the evaluated energy consumptions of the wireless device, and reconfiguring (S6) the wireless device with the selected Scell and/or BWP configuration.

### TECHNICAL FIELD

The present disclosure relates to wireless access networks, and in particular to energy efficient configuration of component carriers during a carrier aggregation (CA) mode of operation in the wireless access network. There are also disclosed methods for configuring bandwidth parts (BWP) of a wireless access network in an energy efficient manner.

### BACKGROUND

Some recent wireless access systems implement a CA feature, where a wireless device may communicate via more than one radio carrier in order to increase the obtainable data rate on the uplink (UL) from the wireless device to the network and/or on the downlink (DL) from the network to the wireless device.

The third generation partnership program (3GPP) has also specified a dual connectivity (DC) mode of operation, where a wireless device may communicate over more than one radio access technology, e.g. both a long term evolution (LTE) radio carrier and a new radio (NR) carrier.

Both the CA mode of operation and the DC mode of operation potentially provide both increased throughput and reduced latency. However, this increase in performance normally comes at the cost of an increase in the power consumption at the wireless device, which is undesired.

A key feature of CA is that multiple serving cells may be dynamically configured for a wireless device on demand. The configured multiple serving cells are normally referred to as the primary cell (PCell) which performs key functions such as random access, and secondary cells (SCell) which primarily support data transfer. The activation and deactivation of the SCells is realized by efficient network signaling, allowing the network to change the activation/deactivation status of the SCells quickly. The configuration and function of Scells is discussed in, e.g., 3GPP TS 38.213 v16.6.0 2021-06-30, 3GPP TS 38.321 v16.6.0 2021-09-27, 3GPP TS 38.300 v16.7.0 2021-09-27, and 3GPP TS 38.331 v16.6.0 2021-09-28.

Power consumption of a wireless device operating in CA mode was investigated by Mogenssen et. al. in “LTE UE Energy Saving by Applying Carrier Aggregation in a HetNet Scenario,” 2013 IEEE 77th Vehicular Technology Conference (VTC Spring), Dresden, Germany, 2013, pp. 1-5. By using a power consumption model for a device operating in CA, Mogenssen concluded that CA may reduce the energy consumption of the wireless device. This is because by using CA, the wireless device may finish its transmission/reception faster, and the wireless device can therefore enter sleep mode sooner.

However, in practice, a wireless device, e.g., a smart phone, may have a mixed type of traffic. For example, a user may use a smart phone for streaming video but at the same time a messaging application running in the background to monitor incoming messages. Also, voice-over-IP applications, may have to keep a connection to a server alive, e.g., by using a so-called heartbeat packet, even if there is no data transmission. Furthermore, different wireless devices in a cell may have different traffic types. Using CA, if not configured properly, may not result in the desired energy consumption reduction, especially when several different applications with different traffic characteristics are running at the wireless device, as some applications may prevent the wireless device from entering sleep mode. Hence, there is a continuing need for further improvement.

### SUMMARY

It is an object of the present disclosure to provide improved techniques for energy efficient configuration of one or more secondary component carriers and/or at least one BWP in a wireless access network, this object is at least in part obtained by a computer implemented method, performed in a network node, for configuring one or more Scells and/or at least one BWP in a wireless access network for a wireless device. The method comprises obtaining control channel capacity data indicative of a nominal capacity of a current control channel of the wireless access network and determining a control channel load of the wireless access network. The method also comprises evaluating one or more alternative Scell and/or BWP configurations of the wireless access network for the wireless device in terms of an energy consumption of the wireless device, where each of the one or more alternative Scell and/or BWP configurations of the wireless access network is associated with an increased control channel capacity compared to the nominal capacity of the current control channel, and detecting control channel resource deficit based on the control channel load and on the control channel capacity data, as well as, in response to detecting control channel resource deficit, selecting an Scell and/or BWP configuration from the one or more alternative Scell and/or BWP configurations based on the evaluated energy consumptions of the wireless device, and reconfiguring the wireless device with the selected Scell and/or BWP configuration.

This way a reduced wireless device energy consumption can be obtained. In particular, increased energy consumption of a wireless device due to control channel resource deficit is mitigated. The techniques for network optimization discussed herein provide the network (NW) with efficient strategies in order to activate additional Scells, reconfigure the set of active Scells, and/or switch to a BWP configuration with more control channel resources for the wireless device such that undue increase of wireless device power consumption due to control channel resource deficit is avoided, or at least is reduced.

According to aspects, the control channel capacity data and the control channel load relates to the capacity and the control traffic load of a physical downlink control channel (PDCCH) of the wireless access network. The PDCCH is a commonly used control channel in 3GPP-defined wireless access networks. It is an advantage that the methods can be conveniently adapted for use in 3GPP-defined networks.

According to aspects, the method comprises obtaining the control channel capacity data based on a current configuration of Scells and/or a numerology and/or search space configuration of active BWPs in the wireless access network. These represent efficient mechanisms for obtaining control channel capacity data. It is an advantage that the herein disclosed methods can be implemented based on one or more different network parameters.

According to aspects, the method comprises obtaining the control channel capacity data based on a measure of spectral efficiency for communicating over the control channel. It is an advantage that the control channel capacity data may be based on factors other than consumed communication resources such as time and frequency. These aspects allow consideration of, e.g., channel quality also, which is an advantage. For instance, the control channel capacity data may be advantageously obtained based on a radio link quality parameter indicative of a radio link quality of one or more wireless devices connected to the wireless access network. Generally, by not only considering assigned control channel communications resources but also how efficiently these resources are used by the network, a more relevant measure of control channel capacity is obtained.

According to aspects, the method comprises determining the control channel load at least in part based on any of a number of connected wireless devices in the wireless access network, a data traffic load of the wireless access network, a physical downlink shared channel (PDSCH) utilization in the wireless access network, a scheduling rate of the wireless access network, and/or a PDSCH utilization of the wireless access network. It is an advantage that the method can be based on a large variety of different network parameters, allowing flexibility in implementation and adaptation to different network structures and environments.

According to aspects, the method comprises determining the control channel load at least in part based on a radio link quality associated with one or more wireless devices in the wireless access network. Thus, the load is not necessarily only based on the number of users, or similar counter metrics, but also on radio link quality, which has been shown to be an advantage from a performance point of view. Further advantages may also be obtained by determining the control channel load of the wireless access network at least in part based on data traffic characteristics of the wireless access network, as will be explained in the following.

According to aspects, the method comprises detecting the control channel resource deficit at least in part based on an occurrence of one or more PDCCH blocking events. PDCCH blocking events are relatively easy to monitor, and have been found to represent a reliable and accurate parameter for detecting control channel resource deficit. Physical uplink control channel (PUCCH) blocking events may optionally also be used for detecting control channel resource deficit.

According to aspects, the method comprises predicting a future control channel resource deficit based on a trend of utilization of one or more communications resources of the wireless access network. This allows for proactive action, which is an advantage since it often results in further decreases in energy consumption compared to if no prediction is used. For instance, a future control channel resource deficit may be advantageously predicted based on a trend of PDCCH utilization in the wireless access network.

According to aspects, the method comprises activating one or more additional Scells in the wireless system in response to detecting a control channel resource deficit. The additional Scells provide increased control channel capacity, which potentially lead to decreased wireless device power consumption.

According to aspects, the method comprises selecting a set of active Scells out of a set of available Scells in the wireless access network based on one or more hardware configurations associated with wireless devices connected to the wireless access network. For instance, some wireless devices comprise more than one transceiver. By selecting active Scells based on hardware configurations, there is a possibility to optimize the selection in terms of the number of active transceivers.

According to aspects, the method comprises selecting a set of active Scells out of a set of available Scells in the wireless access network based on one or more estimated radio propagation channel qualities in the wireless access network. This allows for optimizing the set of active Scells to improve radio propagation channel conditions, leading to reduced control channel resource deficit and thus also decreased power consumption in many network scenarios.

According to aspects, the method comprises activating one or more dormant BWPs associated with an increased control channel capacity compared to a current BWP configuration in response to detecting the control channel resource deficit. The dormant BWPs are convenient to activate, and bring additional control channel resources to the network, which often implies a reduction in wireless device energy consumption.

According to aspects, the method comprises reconfiguring the one or more Scells and/or the at least one BWP based on a frequency range of operation of the Scells and/or the BWPs and on a frequency range of operation of one or more radio transceiver circuits of the wireless device. This means, for instance, that the selection can be tailored to a given hardware configuration associated with a decreased energy consumption compared to some other selection, which is an advantage.

According to aspects, the method comprises evaluating an energy consumption parameter based on a model of energy consumption by one or more wireless device types, and reconfiguring the one or more Scells and/or the at least one BWP based on the output of the model. This type of model may be used to increase the accuracy in the selection of network configuration with a target to decrease wireless device energy consumption.

According to aspects, the method comprises detecting a control channel resource surplus based on the control channel load and on the control channel capacity data, and, in response to detecting a control channel resource surplus, reconfiguring the one or more Scells and/or the at least one BWP to decrease the control channel capacity of the wireless access network. Thus, the disclosed methods are also applicable for optimizing control channel resource usage, leading to higher overall spectral efficiency without jeopardizing wireless device energy consumption.

There is also disclosed herein network nodes and computer program products associated with the above-mentioned advantages.

### BRIEF DESCRIPTION OF THE DRAWINGS

The present disclosure will now be described in more detail with reference to the appended drawings, where:

FIG. 1 shows an example wireless access network;

FIG. 2 schematically illustrates a configuration comprising secondary component carriers;

FIG. 3 illustrates activation/deactivation of a secondary component carrier and a bandwidth part;

FIG. 4 schematically shows reconfiguration of bandwidth parts;

FIG. 5 is a flow chart illustrating an example method;

FIG. 6 illustrates a wireless device;

FIGS. 7-9 show some example network node realizations; and

FIG. 10 shows a computer program product;

### DETAILED DESCRIPTION

Aspects of the present disclosure will now be described more fully hereinafter with reference to the accompanying drawings. The different devices, systems, computer programs and methods disclosed herein can, however, be realized in many different forms and should not be construed as being limited to the aspects set forth herein. Like numbers in the drawings refer to like elements throughout.

The terminology used herein is for describing aspects of the disclosure only and is not intended to limit the invention. As used herein, the singular forms “a”, “an” and “the” are intended to include the plural forms as well, unless the context clearly indicates otherwise.

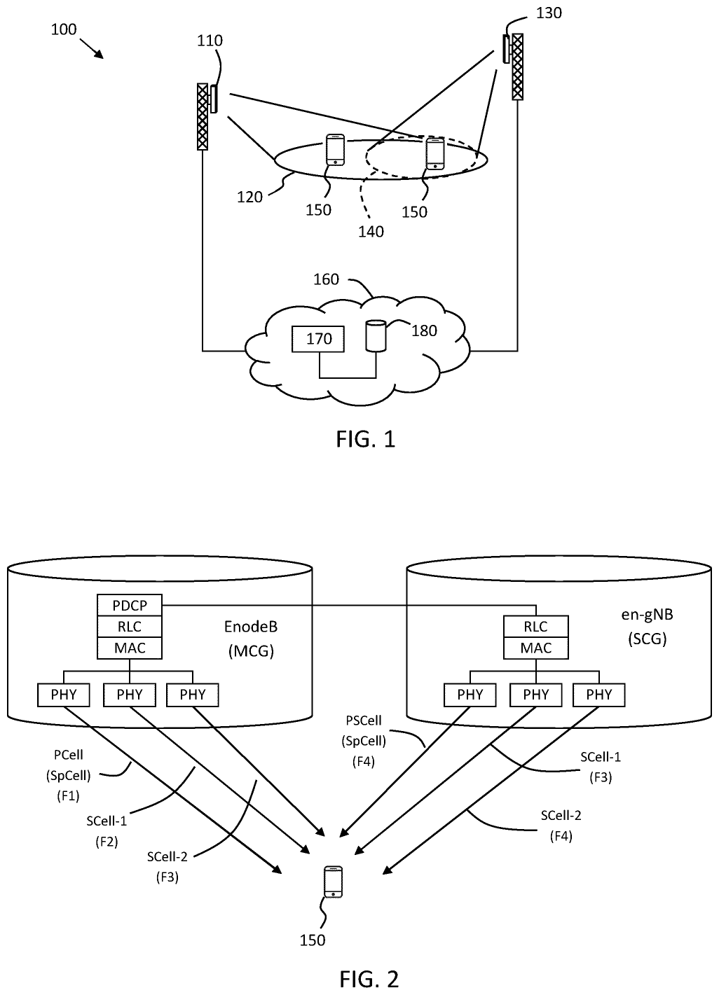

FIG. 1 illustrates an example wireless access network 100, where transmission points (TRP) 110, 130 provide wireless network access to wireless devices 150, also known as user equipment (UE), over respective coverage areas 120, 140. The terms wireless device and UE will be used interchangeably herein, where both terms are to be construed broadly to mean any form of wireless device arranged to associate itself with the wireless access network 100 in some way.

The TRPs 110, 130 may be connected to one or more radio base stations. A radio base station in a fourth generation (4G) 3GPP network is normally referred to as an evolved node B (eNodeB), while a radio base station in a fifth generation (5G) 3GPP network is referred to as a next generation node B (gNodeB or gNB). The TRPs 110, 130 are connected to some type of core network 160, such as an evolved packet core network (EPC), or a fronthaul network. The EPC is an example of a network which may comprise wired communication links, such as optical links. The core network 160 may comprise any number of network nodes 170 for configuration of the wireless access system 100, including provisioning of Pcells and Scells as discussed above. A network node 170 may be connected to a data server 180, allowing it to obtain data for executing its functions. The data server 180 may, e.g., comprise data related to various hardware configurations associated with a given type of wireless device, such as its collection of radio transceivers configured to operate in different frequency bands. The data server 180 may also store models of energy consumption which are configured to model how different network configurations affect the energy consumption of a given type of wireless device.

The wireless access network 100 supports at least one radio access technology (RAT) for communicating 111, 121 with the wireless devices 130, 140. It is appreciated that the present disclosure is not limited to any particular type of wireless access network type or standard, nor any particular RAT. The techniques disclosed herein are, however, particularly suitable for use with 3GPP defined wireless access networks that implement multi-TRP transmission, as discussed above. 5G NR is a RAT developed by 3GPP for the mobile network. It was designed to be the global standard for the air interface of 5G networks. In NR, and LTE, the network can configure the UE with secondary component carriers, or Scells in a CA fashion, as illustrated in the example network configuration in FIG. 2. Furthermore, in NR, a DC mode can be configured where e.g., the anchor cell is in LTE, but PScell handles NR. The configuration and function of Pcells and Scells is discussed in, e.g., 3GPP TS 38.213 v16.6.0 2021-06-30, 3GPP TS 38.321 v16.6.0 2021-09-27, 3GPP TS 38.300 v16.7.0 2021-09-27, and 3GPP TS 38.331 v16.6.0 2021-09-28.

While CA/DC can enable higher throughput, it comes at a larger UE power consumption considering that the UE has to perform regular radio operations, e.g., PDCCH monitoring, channel state information (CSI) measurement and reporting, sounding reference signal (SRS) transmission and so on over one or more additional carriers instead of just one primary carrier. Typically, the wireless access network aims to configure additional carrier components for the sake of performance improvement, i.e., to increase data rates and/or reduce latency.

For instance, if the traffic load is low, a UE configured with multiple component carriers may consume a higher power while the throughput gains are not significant compared to if the UE had been configured with only one component carrier. On the other hand, there may be situations where the UE can actually consume less power having an extra carrier due to emptying buffers more rapidly, compared to the case with a single carrier, e.g., when the number of users to serve in the cell increases beyond a specific limit, and thus there are less scheduling instances available over one carrier. For example, Mogenssen et. al. showed in “LTE UE Energy Saving by Applying Carrier Aggregation in a HetNet Scenario,” 2013 IEEE 77th Vehicular Technology Conference (VTC Spring), Dresden, Germany, 2013, pp. 1-5, that with a given traffic model assumption, when the downlink throughput increases more than 20% in LTE, an additional carrier can help reduce the UE power consumption.

Another important factor that influences UE power consumption is PDCCH monitoring. When the number of UEs in a cell increases, or as the ratio of UEs in bad coverage (with low signal to noise ratio, SNR) compared to UEs in good coverage (higher SNR) increases, the PDCCH resources become limited, and thus the network faces the so called PDCCH blocking problem. That is when the network node needs to schedule a UE for downlink or uplink transmission, the network cannot find PDCCH resources (e.g., in a given period of time) to send the control information for the schedule and resource allocation information for the downlink or uplink transmission. This in turn means the UE gets delayed in receiving PDCCH, and as such the UE wastes power in monitoring PDCCHs with no grants.

It is furthermore appreciated that different combinations of configured component carriers result in different energy consumption levels even though the total aggregated frequency bandwidth (BW) of the carriers is the same. These energy consumption levels are typically device dependent. For example, depending on the UE implementation (and primarily its radio frequency, RF, architecture), it may from an energy consumption point of view be important which of the secondary component carriers are activated by the wireless access network rather than only how many carriers that are activated. These component carriers may be implemented in different transceivers independently power managed. The UE could potentially switch off transceivers/processing chains associated to the carriers when not in use. Hence, for the same number of component carriers, different power consumption levels may be experienced by a UE depending on which component carriers the wireless access network activates.

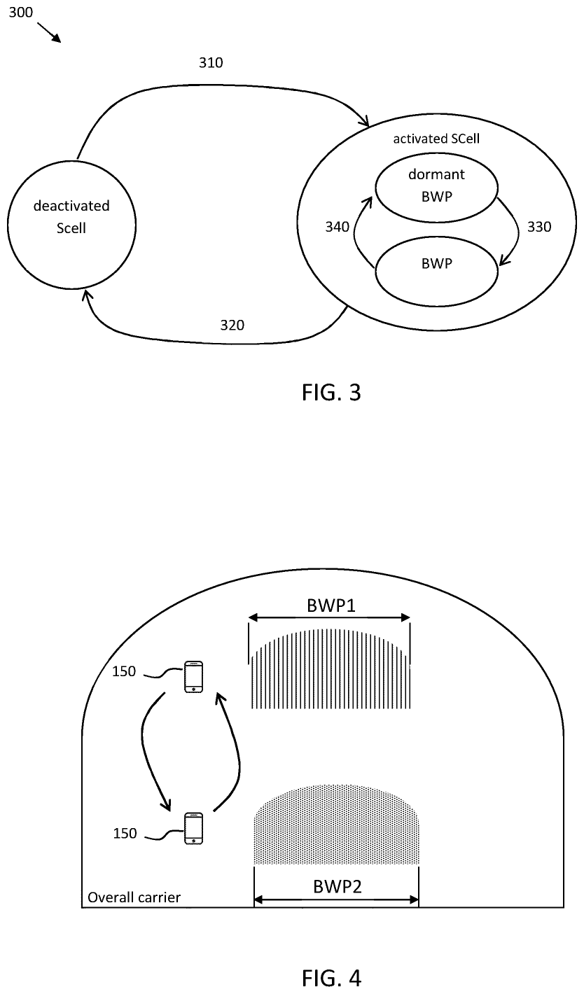

FIG. 3 schematically illustrates activation 310 and deactivation 320 of an Scell 300, and also reconfiguration 330, 340 of a BWP. The practical details of configuring Scells and BWPs is generally known and will therefore not be discussed in depth herein. Based on the above understanding, it is realized that there is a need for efficient mechanisms and strategies that the wireless access network can employ to decide when to activate 310 additional Scells and/or switch to alternative BWP configurations 330, 340 or search space configurations, having a regard to the effect on the power consumption levels of different wireless devices connected to the wireless access network 100. A key part of the strategies presented herein is the avoidance of PDCCH resource deficits, i.e., avoidance of excessive control channel blocking rates, which may lead to significant increases in UE power consumption, at least in some scenarios.

Mechanisms are disclosed herein which allow the wireless access network 100 to determine when to activate additional Scells and/or switch to an alternative BWP configuration with more resources and when to deactivate them. The basis for activation decisions is to consider PDCCH usage and avoid PDCCH blocking due to a large number of users being scheduled on the same CC. The selection of Scells and/or BWPs to activate is made based on an evaluation or prediction of energy consumption of the wireless device. According to the methods and techniques proposed herein, a network node or network control entity keeps track (directly or indirectly) of a nominal capacity of a current control channel of the wireless access network 100. This capacity, as will be discussed in more detail in the following, is not necessarily just a function of the assigned communications resources (frequency bandwidth and total time slot duration), but potentially also radio link quality since this has an effect on the obtainable spectral efficiency or obtainable aggregation level (AL) of communication over the control channel. The network node in charge of configuring Scells and/or BWPs also determines the control channel load of the wireless access network 100, in order to be able to detect when a control channel resource deficit occurs or is about to occur in the near future.

In a preferred implementation the wireless access network 100 is a 3GPP-defined wireless access network, and the control channel capacity data as well as the control channel load relates to the capacity and the control traffic load of a PDCCH of the wireless access network 100.

The control channel capacity data may of course be determined based on a current configuration of Scells and/or a numerology and/or search space configuration of active BWPs in the wireless access network 100. It is however appreciated that the control channel resource deficit may also be indirectly determined, e.g., based on a measured/observed current blocking rate of the control channel, or a predicted future blocking rate. Thus, obtaining information such as control channel blocking rate is considered equivalent to determining control channel load, since the two are closely related. Some other example criteria for detecting control channel resource deficit and reconfiguring one or more Scells and/or at least BWP in the wireless access network 100 for the wireless device 150 may, for example, include one or more of: the load in the cell, in terms of number of users and/or traffic load, PDCCH utilization, PDSCH utilization, Frequency range, UL and DL utilization, and also UE assistance/preference. Optionally, the network node also evaluates one or more alternative Scell and/or BWP configurations of the wireless access network 100 for a given wireless device 150 in terms of an energy consumption of the wireless device 150. Thus, information about alternative configurations is available, where at least some of the available configurations are associated with an increased control channel capacity compared to the nominal capacity of the current control channel. This means that the network node is able to quickly select an Scell and/or BWP configuration from the one or more alternative Scell and/or BWP configurations and reconfiguring the wireless device with the selected Scell and/or BWP configuration when it is determined that this would be beneficial for the energy consumption of the wireless device.

An example scenario will now be considered where the UE has reported capability of CA/DC for one or more frequency band combinations to the network node with one or more additional component carriers in addition to the primary component carrier, or Pcell. Furthermore, the network has configured one or more secondary component carriers based on UE capability. Hereby, mechanisms are provided with which the wireless access network can decide to when, how many and which Scell to activate, and when to deactivate currently active Scells. One of the main criteria to make the decision is to achieve UE power savings and also to ensure additional CC availability when needed. The criteria and conditions described herein in order to decide to activate or deactivate Scells for UE power savings can be readily applied for the case of Scell dormancy, i.e., bringing the Scell from dormant mode to the non-dormant mode (equivalent to activating Scell), and vice versa.

Throughout the disclosure, the term BWP resources is not limited to increase in frequency resources where the UE is switched to a new BWP having a larger bandwidth, but could also mean time-domain resources where the UE is switched to a BWP of same BW but with a densified search space configuration compared to the originating BWP, as illustrated in FIG. 4 where BWP2 has a densified search space compared to BWP1. In FIG. 4, a wireless device 150 which is configured with BWP1 has a less dense search space compared to a wireless device 150 configured with BWP2. Hence, the term BWP resource shall be interpreted herein as frequency- and/or time-domain resources. If only time-domain resources are to be added for the sake of solving the issues herein, it shall be understood that throughout the document, other mechanisms such as switching/reconfiguring the UE search space can be used instead of BWP switch.

A number of example implementations of the proposed method to configure one or more Scells and/or at BWP in a wireless access network 100 for a wireless device 150 will now be given.

The Load in the Cell (Number of Users and Traffic Load)

According to a first example, the wireless access network is set up to activate one or more additional Scells and/or switch to BWP or search space configuration with more resources for the UE based on the number of users being served in the cell and the required ALs and/or number of retransmissions involved for each of the UEs depending on the associated link quality of each UE (the wireless access network typically has to use a higher AL for a UE in poor coverage consuming more PDCCH resources). In other words, the control channel capacity is often determined in part by a measure of spectral efficiency (e.g., in terms of information bits per second per Hz) for communicating over the control channel.

The availability of more Scells increases the scheduling opportunities, both PDCCH and PDSCH resources, thus allowing faster emptying of the buffers. The wireless access network can determine a set of thresholds for different traffic loads/intensity (i.e. not only dependent the user data buffer size but also the scheduling rate/intensity wherein each scheduling activity including potential retransmissions consumes PDCCH resources irrespective of the user data size) associated with the number of users, and the associated coverage of each user affecting the PDCCH AL, such that when the threshold is passed an additional Scell is configured. Thus, in this example, obtaining control channel capacity data indicative of a nominal capacity of a current control channel of the wireless access network, determining a control channel load of the wireless access network, and detecting a control channel resource deficit based on the control channel load and on the control channel capacity data amounts to monitoring the load in the cell (number of users and traffic load) and comparing the monitored load to some predetermined acceptance criteria, such as a threshold on number of users and/or traffic load in the cell.

For example, two UEs in bad coverage may consume more PDCCH resources than 3 UEs in good coverage. The set of thresholds can be determined such that by adding additional Scells and/or switch to BWP or search space configuration with more resources the UE can achieve a lower power consumption. It shall be noted that the UE may be further configured with time domain configuration related parameters that affect the UE scheduling availability and hence the total time spent by the UE in connected mode before the service is served. E.g., the UE may be configured with connected DRX (C-DRX) and/or a sparse PDCCH monitoring occasion. Hence, if the number of users being served in the cell is higher than a specific threshold for a specific traffic load, the UE may stay longer in active time if it is only served with one carrier, than it would have stayed in the active time, if it is served with more than one carrier, and thus the wireless access network decides to activate one or more additional carrier(s) to help the UE achieve power savings. In other words, the power benefit from reduced active time duration is larger than the power penalty from more active CCs. Moreover, if the number of users went beyond a second threshold after the first threshold, the wireless access network may decide to activate yet another Scell, and so on.

Additionally, the wireless access network may decide which of the configured Scells to activate based on different criteria. E.g., if one Scell is in FR1, and the other Scell is in FR2, or simply a higher frequency range, but the frequency bandwidth (BW) is similar, the wireless access network may decide to activate the Scell in the lower frequency to help the UE achieve a lower power consumption, as certain radio frequency (RF) component(s) consumes more power. In addition, as mentioned above that the currently active UEs link may affect the PDCCH resource consumption, the wireless access network may decide to which of the configured SCells to activate based on the BW or the number of resources elements (or PRBs) that can be provided by the inactive cell. For example, if around 30 MHz of BW is required to reduce the PDCCH-blocking to the desired rate, and there are 40 MHz cell and 80 MHz cell, the wireless access network may choose to activate the 40 MHz cell. But if 60 MHz of BW is required, the wireless access network may choose to activate the 80 MHz cell.

Similar principles may be used to deactivate one or more active Scells. If the load decreases, Scells may be deactivated according to thresholds similarly to the activation thresholds, or hysteresis may be used, and the threshold may be made different (reduction threshold for the load value is made higher) to avoid ping-ponging between varying numbers of active Scells.

For the sake of simplifying the understanding of the above, an exemplary simple wireless access network implementation is outlined here. Assume a simple scenario in which all configured DL slots are available for connected mode user data transmission in a cell of 100 MHz BW with 30 kHz subcarrier spacing and a TDD configuration pattern with 4DL, 2UL, 4DL (i.e., 16 DL slots available for PDCCH per ms). In such a cell PDCCH can be provided over 45 control channel elements (CCEs). Let's assume further that the wireless access network configures the UEs with a search space (SS) candidate configuration of AL: 2×AL16, 2×AL8, 3×AL4, 4×AL2, 5×AL1, where each aggregation level implies 6 CCEs, and where AL16 is necessary for encoding PDCCH for UEs of poor coverage (low SNR) while AL1 is used for encoding PDCCH for UEs of excellent coverage (high SNR). Note that all these AL combinations cannot be used simultaneously at same PDCCH transmission occasion because then that would exceed the total of 45 CCEs. It is noted that this way, the network obtains control channel capacity data based on a radio link quality parameter indicative of a radio link quality of one or more wireless devices connected to the wireless access network 100.

Based on this example, two poor coverage UEs can be served per DL slot (2×AL16). Since our TDD pattern example gives us 16 DL slots per ms, this means that we can serve 32 poor coverage UEs per ms, i.e., 3200 poor coverage UEs per second at 100% DL duty cycle. Assume however, that we don't have the 100% DL duty cycle and instead for the sake of UE power saving, connected mode DRX (C-DRX) is configured with 160 ms and 10 ms onDuration, i.e. an availability/duty cycle of 10/160. This means then instead that the wireless access network can serve 200 poor coverage UEs during 1 sec (i.e., 50 UEs during if the search space is configured with every slot available for PDCCH, i.e. search space configuration sl1 or 100 poor coverage UEs during 1 sec (i.e., 50 UEs during 0.5 s) if PDCCH search space is configured with every other slot availability, i.e. sl2.

In the configuration example sl1: Assume that we don't want to delay the scheduling towards a UE more than 0.25 sec (500 slots) because keeping that specific UE in connected DRX and letting it decode PDCCHs during onDurations during that period (˜30 PDCCH occasions) is more energy consuming for that UE than activating other carrier components and serving it during shorter time and thereafter release the UE to idle if no more data exchange is ongoing afterwards.

In the configuration example sl2: Since in sl2, the UE monitors every other DL occasion instead, then ˜30 PDCCH occasions correspond to connected period of 0.5 sec (1000 slots) instead.

Based on the above, we define a threshold and set it to some value, say 50. So long as the number of simultaneously connected poor coverage UEs are below this threshold, the wireless access network continues to serve the UEs on the serving cell. However, when more than 50 such UEs are in connected mode competing for the PDCCH resources of same configurations, then the wireless access network activates secondary cells for serving the UEs with power saving benefits while maintaining performance. This amounts to detecting a control channel resource deficit based on the control channel load (here represented by the number of simultaneously connected poor coverage UEs) and on the control channel capacity data (here exemplified by the threshold set to 50 such UEs). When a control channel deficit is detected, the network selects an alternative Scell configuration associated with an increased control channel capacity compared to the nominal capacity of the current control channel, which alternative configuration is also estimated to result in a reduced UE power consumption.

Note that a similar handling can be expanded and performed for UEs of various coverage served by other ALs. In such case of a weighting parameter could be used for each type of UE when comparing to a threshold, e.g. 8 good coverage UEs (served by AL2) take the same amount of resources as 1 poor coverage UE (AL16).

PDCCH/PDSCH Utilization

According to a second example, PDCCH and PDSCH utilization are instead used to detect control channel resource deficit, however, the same examples apply readily to the case of PUCCH and PUSCH.

The wireless access network may decide to activate one or more additional Scells and/or switch to BWP configuration or search space configuration with more resources if the number of blocked PDCCH events per time unit, or the average rate of blocking, goes beyond a specific threshold. The blocked PDCCH can be defined by the wireless access network attempt to transmit a PDCCH to a UE, but not being able to as at the same time and frequency resources, the wireless access network has to send PDCCH to other UEs. Blocked PDCCH attempt leads to the UE staying in active time for a longer time (e.g., when the UE is further configured with C-DRX), or in general, longer data transmission duration, and thus a larger power consumption. As such, in one example, the wireless access network may decide to activate an additional carrier and/or change the BWP or SS configuration for the UE if X out of Z PDCCH attempts turned out to be blocked, and further activate one more of Y out of Z PDCCH attempts are blocked, where Y>X. The wireless access network may further determine the X and Y value differently, e.g. based on the UE currently running application, etc. Thus, in this example obtaining control channel capacity data indicative of a nominal capacity of a current control channel of the wireless access network, determining a control channel load of the wireless access network, and detecting a control channel resource deficit at least in part based on an occurrence of one or more PDCCH blocking events.

According to other aspects, the PDCCH blocking our resource limitation is a result of UE BW limitations due to UE power savings or simply a wireless access network deployment limitation, e.g., a wireless access network capable of 100 MHz cell deployment may typically want to configure the UE with a BW of 100 MHz per carrier to achieve best performance, but a UE e.g., due to power savings or reduced capability supports a maximum frequency bandwidth (BW) of 20 MHz. Alternately, in some deployments, despite having UEs capable of 100 MHz BW, the wireless access network may simply not have 100 MHz available but for example only 40 MHz available per cell. As such the PDCCH blocking probability in a cell increases in these cases. Therefore, the wireless access network may consider different thresholds as discussed above for activation of Scells depending on the UE and/or wireless access network capability and the used BW.

According to further aspects, in the same way, the wireless access network may decide to activate additional Scells and/or switch to a BWP or a search space configuration with more resources based on PDSCH utilization. E.g., the wireless access network may note that the number of required physical resource blocks (PRBs) to schedule the PDSCH, relative to the whole number of available PRBs are lower than a threshold, and as such the UE has to stay longer in active time (e.g., if it is further configured with C-DRX), and, hence consuming more power. In such a case, the wireless access network may decide to activate an additional carrier, and if the relation goes even below a second threshold, the wireless access network may decide to activate even one more carrier, etc. Similarly, the wireless access network may further determine the threshold differently, e.g. based on the UE currently running application, etc. As in the PDSCH shares DL resources with PDCCH, the PDSCH utilization may imply a PDCCH resource deficiency. Again, this is an example of detecting a control channel resource deficit based on the control channel load (here inferred from PDSCH utilization) and on the control channel capacity data (implicit). When a control channel deficit is detected, the network selects an alternative Scell configuration associated with an increased control channel capacity (additional Scells are activated) compared to the nominal capacity of the current control channel, which alternative configuration is also estimated to result in a reduced UE power consumption.

Similar principles may again be used to deactivate one or more active Scells. If the blocking rate decreases, Scells may be deactivated according to thresholds similarly to the activation thresholds, or hysteresis may be used, and the threshold may be made different (reduction threshold for the blocking probability is made higher) to avoid ping-ponging between varying numbers of active Scells.

According to an example, the wireless access network may consider the PDSCH utilization of all the served UE, i.e. based on the total number of currently available PRBs of all UEs and the required PRBs to schedule all of the UEs. In one example realization the wireless access network may activate additional carriers of all UEs currently having at least one inactive carrier. In another example realization, the wireless access network may select which UE that needs to activate an additional carrier in order to reduce energy consumption. The determination of which UE that needs to activate additional carriers might be based on the individual PDSCH utilization in each UE, e.g. the UE which currently has the smallest ratio between the currently available PRB and the required PRB may have the highest priority to have its inactive SCell to be activated. The required PRB, in one example, can be based on the statistic on the traffic, e.g., the UE having larger mean packet size and or shorter inter-arrival time may be assumed to require a larger number of PRBs.

Statistics on Traffic History

According to a third example, the wireless access network may decide to activate one or more additional carriers or reconfigure BWPs based on the statistics on the traffic history. For example, if the expected data burst length is above a certain threshold (e.g. more than the time that is normally required for SCell activation), the wireless access network may decide to activate the additional carrier. Additionally, the data inter-arrival time might also be taken into consideration. For example, if the data burst length is short but the data inter arrival time is also relatively short, the wireless access network may consider activating additional carriers if required. Also, if the data burst is short but the data inter arrival time is very long (e.g. more than time required for SCell activation) the wireless access network may decide to not activate the additional carrier. This is an example of determining the control channel load of the wireless access network 100 at least in part based on data traffic characteristics of the wireless access network 100.

Frequency Range, UL/DL, and UE Characteristics

According to a fourth example, the wireless access network my decide to activate an additional carrier in frequency range one (FR1), if the Pcell for the UE is in frequency range two (FR2). In a related example, the wireless access network may decide to do so only for UL and not the DL, or vice versa.

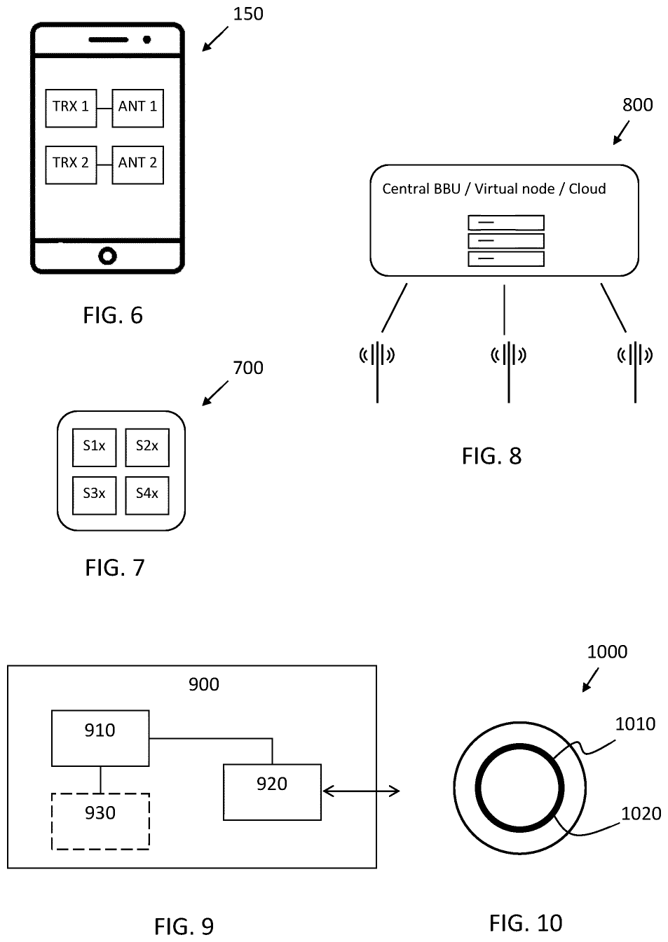

For each direction of communication (UL/DL) the wireless access network also considers the UE energy cost affected by activating the extra component carrier considering the characteristics of this extra carrier combined with the characteristics of the already active component carriers (PCell or other SCells). More specifically, various component carriers may in some cases be supported in the UE by different RF transceivers which are independently power managed. Typically, component carriers belonging to different frequency ranges (FR1/FR2), or even belonging to different bands of the same frequency range maybe served by different transceivers. Each active transceiver chain results in extra power consumption in the UE. As a result, it may be so that the power consumption levels in the UE differ for the very same amount of component carriers depending on the combination of component carriers. FIG. 6 illustrates an example wireless device comprising two transceivers TRX 1 and TRX 2, arranged to operate in different frequency bands. Normally, it is beneficial from an energy consumption point of view to deactivate one of the transceivers, and only use the other. This may be achieved by a proper Scell configuration in the wireless access network for the wireless device 150.

As such, even though based on assessments in previous aspects, it is assumed that the UE would benefit from an additional configured SCell in a certain load scenarios (number of users/PDCCx utilization, etc), further consideration is introduced here to also consider SCell characteristics. I.e. in case of intra-band carriers UE is configured with extra carriers as identified in those aspects. However, in case the situation is different e.g. the currently available low loaded carrier that potentially can be configured as an extra carrier is on another frequency range/band, the Scell is not immediately added. In such case, the threshold for activating another carrier becomes higher. Perhaps it is less power consuming for the UE to remain on the already configured carrier(s) even though scheduled less often leading to a longer total connected mode activity.

According to some aspects, the UE can convey information about its preference for which (rather than only amount) of the secondary carriers it prefers to operate on and which ones it would rather have deactivated/deconfigured/dormant. Based on such information, the wireless access network knows which of the carriers it should preferably operate on for this specific UE.

This may be enabled by having a common agreement between the UE and the wireless access network that certain contradicting combinations of the information elements (IE) in the “UE Assistance Information” specified in 3GPP TS 38.331 v16.6.0 2021-09-28 for power saving/overheating can be used as code points for conveying such information to the wireless access network. In general such combination is enabled by indicating 0-BW (in IE maxBW-Preference) together with non-zero CCs (in IE maxCC-Preference:ReducedMaxCCs) for the same direction, i.e., DL or UL.

According to other aspects, the UE indicates which of the presently configured CCs it would like to have (de)configured/(de)activated/dormant by indicating 0-BW and using the bits in MaxCC-Preference for addressing specific CCs that the wireless access network have already configured. For example, the wireless access network might have configured the UE with one NR PCell, and 3 SCells. The UE may then signal and reducedCCsDL=1 to indicate that it does not prefer the first SCell configured by the wireless access network.

In another embodiment, rather than indicating a single CC per signaling, a combination of CCs is addressed through this signaling. This is specifically beneficial in case multiple SCells are set up by the wireless access network and the information is preferably done through as few signals as possible. Assume for example that from the configuration exemplified above where 3 Scells were set up by the wireless access network, that the UE does not prefer two of them. Then in this embodiment, instead of the previous example in which the UE signaled that it would like to have the first SCell removed and then later signal again to address another CC, it could signal that it does not prefer to have neither the first nor the third by indicating 0-BW and reducedCCs=3 (i.e. binary 101 where the 1 indicates which of the configured CCs the UE would like to have removed); i.e. done through a single indication.

Based on the information provided above, the wireless access network may act and (re-)configure to best tailor the CCs to UE operation excellence in terms of power saving and/or overheating. In essence, the network periodically evaluates one or more alternative Scell and/or BWP configurations of the wireless access network 100 for a wireless device 150 in terms of an energy consumption of the wireless device 150, where each of the one or more alternative Scell and/or BWP configurations of the wireless access network 100 is associated with an increased control channel capacity compared to a nominal capacity of the current control channel configuration in the network for the wireless device. The network detects control channel resource deficit based on the control channel load and on the control channel capacity data, e.g., using one or more of the principles discussed above, and, in response to detecting control channel resource deficit, selects an Scell and/or BWP configuration from the one or more alternative Scell and/or BWP configurations based on the evaluated energy consumptions of the wireless device, and reconfigures the wireless device with the selected Scell and/or BWP configuration.

The converse logic may of course also apply. I.e., the UE signaling may potentially indicate which of the CCs the UE would like to keep instead of which ones it would like to have deactivates/deconfigured/dormant.

In other words, the wireless access network constantly keeps track of the associated energy cost of loaded carrier implications on scheduling delays compared to associated energy cost implicated by characteristics of the carrier. Based on this cost tracking, the wireless access network reconfigures the UE when beneficial for UEs power savings. When the wireless access network determines that it could be beneficial to add SCells, the wireless access network may reconfigure the UE to another set/combination of component carriers (i.e. change active PCell/SCells) so that potentially the same RF chains can be used in the UE.

In order for the wireless access network to take the incremental power cost in combination with other activated CCs into account, the wireless access network may use available info about the UE HW configuration and preferences. In one embodiment, the UE provides information (either explicitly or implicitly) about which CCs share the same transceiver stage, or which combinations of CCs cause minimal energy consumption. In another embodiment, the wireless access network may assume that CCs share the same transceiver if they are in the same FR, same frequency band, or within a certain relative or absolute adjacent frequency span.

Existing Wireless Access Network Mechanisms for Scell Activation/Deactivation, and Scell Dormancy

In all the examples above, when the wireless access network decides to activate one or more additional Scells, the wireless access network indicates that through a MAC CE Scell activation command on the Pcell, and thus the UE starts the Scell activation process. For deactivation, the wireless access network similarly signals MAC CE Scell deactivation for the relevant Scells.

Above, Scell power saving and traffic handling compromise for the long-to medium time scale is achieved by adaptively activating/deactivating Scells. Alternatively or additionally, the wireless access network may use the LTE Rel-16 Scell dormant BWP approach.

The activation/deactivation criteria above may also be applied when dormancy instead of deactivation is used for Scell power saving. The mechanism for dormancy adaptation is DCI-based signaling on the Pcell during active time or before a relevant onDuration. Here, the same criteria used to bring the UE from Scell deactivate more to active mode can be used to bring the UE from Scell dormancy to non-dormancy, and vice versa.

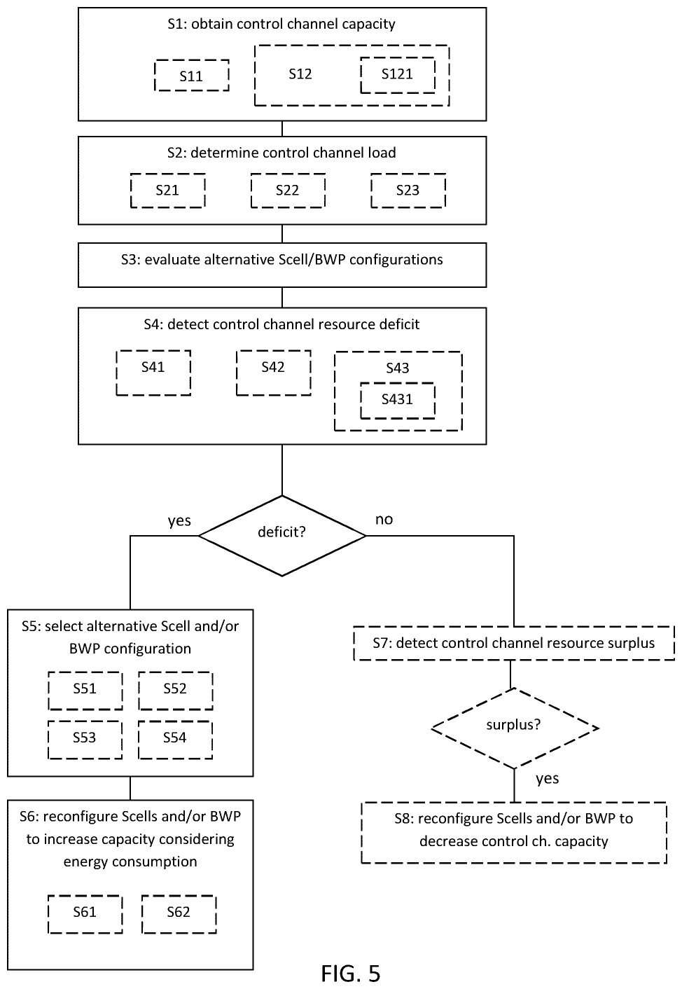

FIG. 5 is a flow chart which illustrates some methods that summarize the discussion above. The methods may be implemented for execution on a network node. This network node may be a stand-alone network component, or a system of sub-nodes distributed over the wireless access network 100. Some example hardware realizations 700, 800, 900 of the network node will be discussed in more detail below in connection to FIG. 7, FIG. 8 and FIG. 9. There is illustrated a computer implemented method, performed in a network node 170, 700, 800, 900, for configuring one or more secondary component carriers (Scells) and/or at least one bandwidth part (BWP) in a wireless access network 100 for a wireless device 150.

The method comprises obtaining S1 control channel capacity data indicative of a nominal capacity of a current control channel of the wireless access network 100. The control channel capacity data may, e.g., be obtained S11 based on a current configuration of Scells and/or a numerology and/or search space configuration of active BWPs in the wireless access network 100. It is appreciated that the capacity of a control channel is not only a function of its assigned communications resources, such as its total aggregated bandwidth and allocated time slots. The capacity of a control channel is also a function of the spectral efficiency obtained by a wireless device communicating over the control channel, which in turn is a function of, e.g., CSI, distortion, and the like. Thus, a wireless device located on the outskirts of the coverage area of a cell may not be able to communicate efficiently over a control channel, despite large bandwidth. It is also realized that the capacity of a control channel in a wireless access network can be increased by adding more communications resources like frequency bandwidth and time, but also by improving the radio propagation channel between the wireless device and the transmission point or points. Thus, a given control channel configuration may actually have a smaller capacity compared to an alternative control channel configuration which is associated with a smaller amount of communications resources in terms of frequency bandwidth and time, but has better radio propagation channel. Consequently, the method may comprise obtaining S12 the control channel capacity data based on a measure of spectral efficiency for communicating over the control channel Spectral efficiency, normally measured in terms of information bits per second and Hz, is a well known measure that can be estimated based on signal to noise ratio (SNR) or similar measures such as received signal strength (RSS) The spectral efficiency associated with a given wireless device and transmission point in the network can be estimated based on, e.g., the capability of the wireless device (i.e., how advanced it is, and which hardware it carries), and also the radio propagation channel quality it presently sees to the transmission point. According to an example, the method comprises obtaining S121 the control channel capacity data based on a radio link quality parameter indicative of a radio link quality of one or more wireless devices connected to the wireless access network 100. The control channel capacity may, as discussed above, also be indirectly obtained from, e.g., measurement of control channel blocking event or the like, or inferred from the number of active users in a cell or area of the wireless access network.

The method also comprises determining S2 a control channel load of the wireless access network 100. The control channel load is a measure of the occupancy of the control channel resources assigned by the network. The load is not a function of spectral efficiency. Rather, the load is a measure of how much of the assigned communications resources that are used by wireless devices in the wireless access network 100. According to a preferred implementation of the method, the control channel capacity data and the control channel load relates to the capacity and the control traffic load of a PDCCH of the wireless access network 100 and/or a physical uplink shared channel (PUSCH) of the wireless access network 100.

The method may, for instance, comprise determining S21 the control channel load at least in part based on any of a number of connected wireless devices in the wireless access network 100, a data traffic load of the wireless access network 100, a PDSCH utilization in the wireless access network 100, a scheduling rate of the wireless access network 100, and/or a physical uplink shared channel, PDSCH, utilization of the wireless access network 100.

As discussed above, radio link quality may have a profound effect on the control channel load, since wireless devices associated with a good radio propagation channel will be able to communicate more efficiently with less retransmission. The method may therefore comprise determining S22 the control channel load at least in part based on a radio link quality associated with one or more wireless devices in the wireless access network 100. The method may furthermore comprise determining S23 the control channel load of the wireless access network 100 at least in part based on data traffic characteristics of the wireless access network 100. The data traffic characteristics may, e.g., comprise data burst length, data inter-arrival time, and so on.

The method also comprises evaluating S3 one or more alternative Scell and/or BWP configurations of the wireless access network 100 for the wireless device 150 in terms of an energy consumption of the wireless device 150, where each of the one or more alternative Scell and/or BWP configurations of the wireless access network 100 is associated with an increased control channel capacity compared to the nominal capacity of the current control channel. It is appreciated that the evaluating part of the method is to be construed broadly to encompass any form of continuous, periodic, or predetermined evaluation. Thus, the network keeps track of one or more alternative Scell and/or BWP configurations by which it can increase the capacity of the control channel in the wireless access network. It is again noted that the alternative control channel configurations may not necessarily be associated with increased amount of communications resources, i.e., more time and/or frequency. Rater, the alternative control channel configurations may also comprise configurations with less communications resources compared to the current configuration, but where the spectral efficiency is estimated to be superior to the current configuration. This can be achieved by using models of spectral efficiency for one or more wireless devices in the network, together with, e.g., radio propagation maps over the coverage areas of the different cells in the network. Thus, as a wireless device moves around over the total aggregated network coverage area, the predicted control channel capacities will change.

The method furthermore comprises detecting S4 control channel resource deficit based on the control channel load and on the control channel capacity data. It is noted that this detection of control channel resource deficit may be performed after the fact, i.e., when the control channel load no longer fulfils some predetermined load acceptance criteria, or it can be based on a predicted future state of the wireless access network. In case a prediction of control channel load is used, then the reconfiguration can be started sooner, which is an advantage since the network operation will not be as effected by an increase in control channel load as it would otherwise have been.

According to some aspects, the method comprises detecting S41 the control channel resource deficit at least in part based on an occurrence of one or more PDCCH blocking events. PDCCH blocking events are of course indicative of a control channel resource deficit. A higher capacity control channel configuration is less likely to suffer from frequent PDCCH blocking events. The method may also comprise detecting S42 the control channel resource deficit at least in part based on an occurrence of one or more PUCCH blocking events.

As discussed above, the control channel resource deficit may either be detected after it has already occurred, or it can be predicted. Predicting an imminent control channel resource deficit is advantageous since then action can be taken to mitigate the effects of the resource deficit before the wireless access network is adversely affected by the control channel resource deficit. Thus, the method may comprise predicting S43 a future control channel resource deficit based on a trend of utilization of one or more communications resources of the wireless access network 100. For instance, the method may comprise comprising predicting S431 the future control channel resource deficit based on a trend of PDCCH utilization in the wireless access network 100. The prediction may be alternatively based on the information of the buffer status of the wireless devices served by a network node, or the number of wireless devices attempting to attached to the network work node.

Now, if a current or future control channel resource deficit is detected, then the method selects S5 an Scell and/or BWP configuration from the one or more alternative Scell and/or BWP configurations based on the evaluated energy consumptions of the wireless device. This means that the network examines its alternative configurations and picks one which it thinks will yield the best performance according to a performance criterion which comprises wireless device energy consumption. As discussed above, the energy consumption of a given wireless device may well be hardware dependent. Following the selection, the network reconfigures S6 the wireless device with the selected Scell and/or BWP configuration.

As discussed above, the method may comprise activating S51 one or more additional Scells in the wireless system 100 in response to detecting a control channel resource deficit, however, the method may also result in selecting S52 a set of active Scells out of a set of available Scells in the wireless access network 100 based on one or more hardware configurations associated with wireless devices connected to the wireless access network 100, or selecting S53 a set of active Scells out of a set of available Scells in the wireless access network 100 based on one or more estimated radio propagation channel qualities in the wireless access network 100, as discussed above. FIG. 6 illustrates a wireless device having two transceivers TRX1 and TRX2 connected to respective antenna systems ANT1 and ANT2. It is normally beneficial if one of these transceivers can be turned off, i.e., dormant. A careful selection of Scell configuration and/or BWP configuration may allow this, while other configurations may not. This is one example of how a given Scell, or BWP configuration may have dramatically different UE power consumption compared to another one, seemingly equal configuration in terms of bandwidth and time assignment.

In addition to Scell configuration, BWP configuration is a tool which the network has at its hands for reconfiguring the control channel. The method may, for instance, comprise activating S54 one or more dormant BWPs associated with an increased control channel capacity compared to a current BWP configuration in response to detecting the control channel resource deficit.

The method may comprise evaluating an energy consumption parameter based on a model of energy consumption by one or more wireless device types, and reconfiguring S62 the one or more Scells and/or the at least one BWP based on the output of the model. This model may either be predetermined, or updated in real time to account for variation in power consumption of different wireless devices for different network configurations. The power consumption may also be fed back to the network from one or more wireless devices and be used to refine the models of power consumption used in the method.

The method may also comprise reconfiguring S61 the one or more Scells and/or the at least one BWP based on a frequency range of operation of the Scells and/or the BWPs, and on a frequency range of operation of one or more radio transceiver circuits TRX1, TRX2 of the wireless device 150.

According to some aspects, the method also comprises detecting S7 a control channel resource surplus based on the control channel load and on the control channel capacity data, and, in response to detecting a control channel resource surplus, reconfiguring S8 the one or more Scells and/or the at least one BWP to decrease the control channel capacity of the wireless access network 100.

FIG. 7 schematically illustrates, in terms of a number of functional modules, the components of a network node 700. The network node comprises an obtaining module (S1x) configured to obtain control channel capacity data indicative of a nominal capacity of a current control channel of the wireless access network (100), a determining module (S2x) configured to determine a control channel load of the wireless access network (100), an evaluating module (S3x) configured to evaluate one or more alternative Scell and/or BWP configurations of the wireless access network (100) for the wireless device (150) in terms of an energy consumption of the wireless device (150), where each of the one or more alternative Scell and/or BWP configurations of the wireless access network (100) is associated with an increased control channel capacity compared to the nominal capacity of the current control channel, and a detection module (S4x) configured to detect control channel resource deficit based on the control channel load and on the control channel capacity data.

The network node also comprises a selecting module (S5x) configured to, in response to detecting control channel resource deficit, select an Scell and/or BWP configuration from the one or more alternative Scell and/or BWP configurations based on the evaluated energy consumptions of the wireless device. The network node furthermore comprises a reconfiguration module (S61) configured to reconfigure the wireless device with the selected Scell and/or BWP configuration.

FIG. 8 illustrates various realizations 800 of the methods, devices and techniques discussed above. The methods and receivers discussed above may be implemented in a baseband processing unit (BBU) which could be deployed in a centralized manner or in a virtual node in the communications network 100. The split between the physical node and the centralized node can be on different levels, e.g. at I/Q samples level from the radio unit. Parts of the proposed methods may of course also be implemented on a remote server comprised in a cloud-based computing platform.

FIG. 9 schematically illustrates, in terms of a number of functional units, the general components of a control unit 900 for a network node according to embodiments of the discussions herein. Processing circuitry 910 is provided using any combination of one or more of a suitable central processing unit (CPU), multiprocessor, microcontroller, digital signal processor DSP, etc., capable of executing software instructions stored in a computer program product, e.g., in the form of a storage medium 930. The processing circuitry 910 may further be provided as at least one application specific integrated circuit ASIC, or field programmable gate array FPGA.

Particularly, the processing circuitry 910 is configured to cause the device 900 to perform a set of operations, or steps, such as the methods discussed in connection to FIG. 5 and the discussions above. For example, the storage medium 930 may store the set of operations, and the processing circuitry 910 may be configured to retrieve the set of operations from the storage medium 930 to cause the device to perform the set of operations. The set of operations may be provided as a set of executable instructions. Thus, the processing circuitry 910 is thereby arranged to execute methods as herein disclosed. In other words, there is shown a network node 900, comprising processing circuitry 910, a network interface 920 coupled to the processing circuitry 910 and a memory 930 coupled to the processing circuitry 910, wherein the memory comprises machine readable computer program instructions that, when executed by the processing circuitry, causes the network node to perform at least some of the techniques disclosed herein.

The storage medium 930 may also comprise persistent storage, which, for example, can be any single one or combination of magnetic memory, optical memory, solid state memory or even remotely mounted memory.

The device 900 may further comprise an interface 920 for communications with at least one external device. As such the interface 920 may comprise one or more transmitters and receivers, comprising analogue and digital components and a suitable number of ports for wireline or wireless communication.

The processing circuitry 910 controls the general operation of the device 900, e.g., by sending data and control signals to the interface 920 and the storage medium 930, by receiving data and reports from the interface 920, and by retrieving data and instructions from the storage medium 930. Other components, as well as the related functionality, of the control node are omitted in order not to obscure the concepts presented herein.

FIG. 7, FIG. 8 and FIG. 9 illustrate examples realizations of a network node 170, 700, 800, 900 arranged to configure one or more Scells and/or at least one BWP in a wireless access network 100 for a wireless device 150. With reference to FIG. 9, the network node comprises processing circuitry 910 configured to obtain control channel capacity data indicative of a nominal capacity of a current control channel of the wireless access network 100, determine a control channel load of the wireless access network 100, evaluate one or more alternative Scell and/or BWP configurations of the wireless access network 100 for the wireless device 150 in terms of an energy consumption of the wireless device 150, where each of the one or more alternative Scell and/or BWP configurations of the wireless access network 100 is associated with an increased control channel capacity compared to the nominal capacity of the current control channel, detect control channel resource deficit based on the control channel load and on the control channel capacity data, and, in response to detecting control channel resource deficit, select an Scell and/or BWP configuration from the one or more alternative Scell and/or BWP configurations based on the evaluated energy consumptions of the wireless device, and reconfigure the wireless device with the selected Scell and/or BWP configuration.

FIG. 10 illustrates a computer readable medium 1010 carrying a computer program comprising program code means 1020 for performing the methods illustrated in, e.g., FIG. 5, when said program product is run on a computer. The computer readable medium and the code means may together form a computer program product 1000.

1. A computer implemented method, performed in a network node, for configuring one or more secondary component carriers, Scells, and/or at least one bandwidth part, BWP, in a wireless access network for a wireless device, the method comprising
obtaining control channel capacity data indicative of a nominal capacity of a current control channel of the wireless access network,
determining a control channel load of the wireless access network,
evaluating one or more alternative Scell and/or BWP configurations of the wireless access network for the wireless device in terms of an energy consumption of the wireless device, where each of the one or more alternative Scell and/or BWP configurations of the wireless access network is associated with an increased control channel capacity compared to the nominal capacity of the current control channel,
control channel resource deficit based on the control channel load and on the control channel capacity data,
and, in response to detecting control channel resource deficit,
selecting an Scell and/or BWP configuration from the one or more alternative S cell and/or BWP configurations based on the evaluated energy consumptions of the wireless device, and
reconfiguring the wireless device with the selected Scell and/or BWP configuration.

2. The method according to claim 1, wherein the control channel capacity data and the control channel load relates to the capacity and the control traffic load of a physical downlink control channel, PDCCH, of the wireless access network.

3. The method according to claim 1, comprising obtaining the control channel capacity data based on a current configuration of Scells and/or a numerology and/or search space configuration of active BWPs in the wireless access network.

4. The method according to claim 1, comprising obtaining the control channel capacity data based on a measure of spectral efficiency for communicating over the control channel.

5. (canceled)

6. The method according to claim 1, comprising determining the control channel load at least in part based on any of: a number of connected wireless devices in the wireless access network, a data traffic load of the wireless access network, a physical downlink shared channel, PDSCH, utilization in the wireless access network, a scheduling rate of the wireless access network, and/or a physical uplink shared channel, PDSCH, utilization of the wireless access network.

7. The method according to claim 1, comprising determining the control channel load at least in part based on a radio link quality associated with one or more wireless devices in the wireless access network.

8. The method according to claim 1, comprising determining the control channel load of the wireless access network at least in part based on data traffic characteristics of the wireless access network.

9. (canceled)

10. The method according to claim 1, wherein the control channel capacity data and the control channel load relates to the capacity and the load of a physical uplink control channel, PUCCH, of the wireless access network and/or a physical uplink shared channel, PUSCH, of the wireless access network.

11. (canceled)

12. The method according to claim 1, comprising predicting a future control channel resource deficit based on a trend of PDCCH utilization of one or more communications resources of the wireless access network.

13. (canceled)

14. The method according to claim 1, comprising activating one or more additional Scells in the wireless system in response to detecting a control channel resource deficit.

15. The method according to claim 1, comprising selecting a set of active Scells out of a set of available Scells in the wireless access network based on one or more hardware configurations associated with wireless devices connected to the wireless access network.

16. The method according to claim 1, comprising selecting a set of active Scells out of a set of available Scells in the wireless access network based on one or more estimated radio propagation channel qualities in the wireless access network.

17. The method according to claim 1, comprising activating one or more dormant BWPs associated with an increased control channel capacity compared to a current BWP configuration in response to detecting the control channel resource deficit.

18. The method according to claim 1, comprising reconfiguring the one or more Scells and/or the at least one BWP based on a frequency range of operation of the Scells and/or the BWPs and on a frequency range of operation of one or more radio transceiver circuits of the wireless device.

19. The method according to claim 1, comprising evaluating an energy consumption parameter based on a model of energy consumption by one or more wireless device types, and reconfiguring the one or more Scells and/or the at least one BWP based on the output of the model.

20. The method according to claim 1, comprising detecting a control channel resource surplus based on the control channel load and on the control channel capacity data, and, in response to detecting a control channel resource surplus, reconfiguring the one or more Scells and/or the at least one BWP to decrease the control channel capacity of the wireless access network.

21. (canceled)

22. A computer program product comprising a computer program for performing a method according to claim 1, and a computer readable means on which the computer program is stored.

23. A network node arranged to configure one or more secondary component carriers, Scells, and/or at least one bandwidth part, BWP, in a wireless access network for a wireless device, the network node comprising processing circuitry configured to
obtain control channel capacity data indicative of a nominal capacity of a current control channel of the wireless access network,
determine a control channel load of the wireless access network,
evaluate one or more alternative S cell and/or BWP configurations of the wireless access network for the wireless device in terms of an energy consumption of the wireless device, where each of the one or more alternative Scell and/or BWP configurations of the wireless access network is associated with an increased control channel capacity compared to the nominal capacity of the current control channel,
detect control channel resource deficit based on the control channel load and on the control channel capacity data,
and, in response to detecting control channel resource deficit,
select an S cell and/or BWP configuration from the one or more alternative S cell and/or BWP configurations based on the evaluated energy consumptions of the wireless device, and
reconfigure the wireless device with the selected Scell and/or BWP configuration.

24. The network node according to claim 23, wherein the control channel capacity data and the control channel load relates to the capacity and the control traffic load of a physical downlink control channel, PDCCH, of the wireless access network.

25. The network node according to claim 23, wherein the control channel capacity data and the control channel load relates to the capacity and the load of a physical uplink control channel, PUCCH, of the wireless access network.
